(19) United States
(12) Patent Application Publication
(10) Pub. No.: US 2023/0339122 A1
(43) Pub. Date: Oct. 26, 2023

(54) ROBOTIC GRASPING HAND

(71) Applicants: B.G. NEGEV TECHNOLOGIES AND APPLICATIONS LTD., AT BEN-GURION UNIVERSITY, Beer Sheva (IL); TECHNION RESEARCH & DEVELOPMENT FOUNDATION LTD., Haifa (IL)

(72) Inventors: Yoav GOLAN, Tel Aviv (IL); Amir SHAPIRO, Meitar (IL); Elon RIMON, Nofit (IL); Gal Shalom LEVI, Petah Tikva (IL)

(21) Appl. No.: 18/002,674

(22) PCT Filed: Jun. 20, 2021
(86) PCT No.: PCT/IL2021/050747

§ 371 Date: Dec. 21, 2022

Related U.S. Application Data
(60) Provisional application No. 63/042,026, filed on Jun. 22, 2020.

(51) Int. Cl. B25J 15/02; B25J 9/16

(52) U.S. Cl. CPC B25J 15/026; B25J 9/1653; B25J 9/1697; B25J 15/0213; B25J 15/0038

(57) ABSTRACT

The present disclosure relates to a robotic grasping hand having a central palm; a plurality of fingers connected to said palm, each of said fingers including a fingertip movable along a length of said fingers; wherein the fingers are placed on a common imaginary plane and are angularly displaceable thereon. The present disclosure relates to a corresponding system and method for activating the grasping hand.

### CROSS-REFERENCE TO RELATED APPLICATIONS

This application is a National Stage application of International Patent Application No. PCT/IL2021/050747, filed on Jun. 20, 2021, which claims priority to U.S. Provisional Patent Application No. 63/042,026, filed on Jun. 22, 2020, each of which is hereby incorporated by reference in its entirety.

### TECHNICAL FIELD

The present invention relates to the field robotics. More particularly, the present invention relates to a gripping device having numerous degrees of freedom with few actuation components.

### BACKGROUND

Conventional mechanical grippers use several “fingertips” that can be either rigid or non-rigid and retract or extend upon an object to form a grasp. These fingertips use contact forces to apply a wrench (force and torque) to the object, allowing it to be grasped and manipulated. Robust grasps overcome external wrenches applied to the grasped object, including gravity, inertial forces and environmental disturbances. Depending on their geometry and mode of operation, each fingertip can have a number of Degrees of Freedom (DOF). For instance, a cylindrical fingertip that moves in a plane has two degrees of freedom (i.e. x and y coordinates). A fingertip can have up to 6 DOF in 3D space. For example, if a 4 fingered robotic hand has 6 DOF for each fingertip, the fingertip's placements are a 24 DOF state.

Typically, a gripping device has the same number of actuators (e.g. motors) as DOFs. If a robotic gripping device has 3 fingertips with 4 DOF each, the gripping device contains 12 actuators to control the individual DOFs. A device with fewer actuators than DOFs is often termed under-actuated. These devices often use compliance to reduce the number of actuators. However, under-actuated devices cannot fully control all DOFs in the device. Rather, under-actuated devices are situational, and often non-deterministic.

Typical grasping devices with few actuators entail simplicity of a robotic hand. On the other hand, numerous actuators enable providing more DOFs, consequentially providing a better grasp of the grasped object. It has been an ongoing challenge to obtain gripper devices having the capability of providing a good grasp but with few actuators, as multiple actuators entail complexity of the gripper device, increase of the grasping device weight and increase of the grasping device construction costs and maintenance costs.

It is therefore an object of the present invention to provide a method and means for grasping and manipulating objects using numerous DOF of the fingertips of a gripper device hand, using substantially fewer actuators than the DOFs.

It is a further object of the present invention to provide a method and means for grasping and manipulating objects utilizing the grasping arm environment to adjust the grasping function.

Other objects and advantages of the present invention will become apparent as the description proceeds.

### SUMMARY

The present invention relates to a device, system and method for grasping an object. The present invention provides a lower number of actuators in relation to the DOFs that it is capable of carrying out. The present invention relates to a grasping hand comprising angularly displaceable fingers, each comprising linearly displaceable fingertips (to engage and grasp the object to be maneuvered). Angularly displacing the fingers and linearly displacing the fingertips may be carried out through various stages prior to grasping the object and in preparation for grasping the object. In this way, the gripper hand may be adjusted prior to the grasping and restructured one DOF at a time.

The present invention relates to a robotic grasping hand comprising:
a central palm;
a plurality of fingers connected to said palm, each of said fingers comprises a fingertip movable along a length of said fingers;
wherein the fingers are placed on a common imaginary plane and are angularly displaceable thereon.

Preferably, the palm comprises:
an upper housing plate comprising a first face gear rotatable therewithin;
a lower housing plate (a bottom housing plate) comprising a second face gear rotatable therewithin;
wherein each fingertip comprises a follower surface member comprising a follower element;
wherein each finger comprises a lead screw along its length passing through said follower element;
wherein each lead screw comprises a spur gear fixedly attached to its proximal side;
wherein each of said spur gears is configured to mesh with said first and second face gears; and
wherein said lead screw and said follower element form a lead screw and follower mechanism.

Preferably, each fingertip comprises a grasping member extending vertically downwards.

Preferably, each finger comprises a proximal vertical surface near its proximal end and a distal vertical surface near its distal end;
wherein each finger comprises one or more rods that pass through the follower surface member and that are fixed between said proximal vertical surface and said distal vertical surface.

Preferably, the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears.

Preferably, the upper housing plate bottom portion comprises a peripheral channel placed around the first face gear;
wherein the lower housing plate top portion comprises a second peripheral channel placed around the second face gear; and wherein the proximal vertical surface comprises a top protrusion placed inside said first peripheral channel and a bottom protrusion placed inside said second peripheral channel.

Preferably, said hand further comprises a thumb finger connected to the palm;
said thumb finger comprises a fingertip movable along its length;
wherein the thumb finger is placed on the common imaginary plane; and
wherein said thumb finger is not angularly displaceable in relation to said palm.

Preferably, the hand further comprises a central shaft anchored to the upper housing plate and lower housing plate;
wherein said shaft comprises a keyseat;
wherein the first or second face gear comprises a keyway; and wherein said hand comprises a key placed within said keayseat and keyway.

Preferably, the distal driving member is a distal plunger surface.

Preferably, said hand further comprises a motor configured to drive and rotate the first or second face gear.

Preferably, the motor is configured to drive and rotate the shaft.

Preferably, the palm is connected to a flat surface and rotatable thereon;
wherein said hand comprises an engaging member configured to engage and displace the distal driving element proximally and configured to rotate it.

Preferably, said hand comprises:
a first motor configured to rotate the palm;
a second motor configured to linearly move the engaging member distally and proximally; and
a third motor configured to rotate the engaging member.

Preferably, said hand further comprises a bearing member comprising a second follower element;
wherein said hand further comprises a second lead screw extending proximally from said second motor and passing through said second follower element;
wherein the second motor is configured to drive and rotate the second lead screw;
wherein said second lead screw and said second follower element form a lead screw and follower mechanism; and wherein the third motor is mounted on said bearing member.

Preferably, said hand comprises a distal vertical bearing surface and a proximal vertical bearing surface; wherein said hand comprises one or more secondary rods that pass through the bearing member and that are fixed between said proximal vertical surface and said distal vertical surface.

Preferably, the hand comprises an axel extending proximally from the third motor and connected to the engaging member such that said third motor is configured to rotate said axel and thereby said engaging member.

Preferably, the distal driving element comprises a protrusion compatible with the engaging member.

Preferably, the engaging member is a universal socket.

Preferably, said hand (e.g., hand 300 explained herein) comprises:
a first motor configured to rotate the palm;
a robotic arm connected to the flat surface, configured to linearly move the engaging member distally and proximally and configured to rotate the engaging member.

The present invention relates to a system for manipulating an object comprising:
a grasping hand as explained herein (according to any one of the embodiments explained herein);
a robotic arm connected to said grasping hand;
a camera; and a control unit comprising a processor.

The present invention relates to a method for grasping and manipulating an object comprising:
providing the system as explained herein;
adjusting the hand for grasping comprising:
   angularly displacing one or more of the fingers; and/or
   linearly displacing one or more of the fingertips;
displacing the hand such that the object is placed within the volume surrounded by the fingertips;
retracting the fingertips proximally to grasp the object;
manipulating the object; and
releasing the object by displacing the fingertips distally.

Preferably, adjusting the hand further comprises the following pre stages:
imaging the object to be grasped;
obtaining a shape resembling the peripheral circumference of the object;
calculating angular positions of the fingers and linear positions of the of the fingertips for grasping according to said obtained shape.

Preferably, providing the hand with the motor configured to drive and rotate the shaft (e.g., hand 100 explained herein);
wherein angularly displacing each finger comprises:
maneuvering the hand such that the finger to be angularly displaced driving member is pushed proximally thereby disconnecting the spur gear from meshing with the face gears; rotating the palm;
maneuvering the hand such that the driving member returns distally thereby positioning the spur gear to mesh with the face gears.

Preferably, providing the hand with the motor configured to drive and rotate the shaft (e.g., hand 100 explained herein);
wherein linearly displacing each fingertip comprises:
maneuvering the hand such that the fingertip to be displaced finger driving member is pushed proximally thereby disconnecting the spur gear from meshing with the face gears; linearly displacing the fingertips of the other hand fingers; maneuvering the hand such that the driving member returns distally thereby positioning the spur gear to mesh with the face gears.

Preferably, (providing a hand e.g. hand 200, 300);
wherein angularly displacing each finger comprises: rotating the palm such that the finger to be angularly displaced driving member is positioned aligned with the engaging member;
displacing the engaging member proximally thereby pushing the driving member proximally and disconnecting the spur gear from meshing with the face gears;
rotating the palm;
displacing the engaging member distally such that the driving member returns distally thereby positioning the spur gear to mesh with the face gears.

Preferably, (providing a hand e.g. hand 200, 300);
wherein linearly displacing the fingertips comprises: rotating the palm such that a finger driving member is positioned aligned with the engaging member;
displacing the engaging member proximally until it engages the finger distal driving member;
displacing the fingertips;
displacing the engaging member distally.

Preferably, (providing a hand e.g. hand 200, 300);
wherein linearly displacing a single fingertip comprises:
rotating the palm such that the finger of the fingertip to be linearly displaced driving member is positioned aligned with the engaging member;
displacing the engaging member proximally thereby pushing the driving member proximally and disconnecting the spur gear from meshing with the face gears;
displacing the fingertip;
displacing the engaging member distally such that the driving member returns distally thereby positioning the spur gear to mesh with the face gears.

### BRIEF DESCRIPTION OF THE DRAWINGS

The present invention is illustrated by way of example in the accompanying drawings, in which similar references consistently indicate similar elements and in which:

FIGS. 1A-1J illustrate an embodiment of the present invention or parts thereof.

FIGS. 2A-2B illustrate positions of an embodiment of the present invention.

FIGS. 3A-3D illustrate positions of an embodiment of the present invention.

FIGS. 4A-4D illustrate positions of an embodiment of the present invention.

FIGS. 5A-5G illustrate an embodiment of the present invention or parts thereof.

FIGS. 6-7 illustrate geometric constraints relating to calculations of positioning the fingertips according to an embodiment of the present invention.

FIG. 8 illustrates an embodiment of the present invention.

FIG. 9 illustrates a system example according to an embodiment of the present invention.

### DETAILED DESCRIPTION

The present invention relates to a gripping system and method for gripping and manipulating objects.

Particularly, the present invention relates to a gripping system and method that includes:
(a) a pre-adjustment stage for adjusting the gripping system prior to a gripping stage; and
(b) the gripping stage for gripping and manipulating an object.
   The pre-adjustment stage (also referred to herein as “adjustment stage”) comprises a plurality of sequential adjustments to the system in order for it to be adapted for grasping and manipulating a particular object. This adjusting of the system enables the system to function with a reduced number of actuators needed to drive the system, in relation to the DOF that the system provides.

The present invention is advantageous as it improves upon fully-actuated grippers by reducing the number of actuators needed to control the gripper's DOFs. On the other hand, the present invention is advantageous as it improves upon under-actuated grippers by allowing full control of the gripper DOF's without sacrificing determinism.

The present invention enables use of fewer actuators in the gripping system hand device than the hand device DOF. Full freedom is achieved by augmenting the hand device with sequential adjustments of the gripping hand device prior to gripping an object. The adjustments of the hand device change the hand device structure, so that it grips the intended object in the intended manner when actuated.

This allows the gripping hand device to contain a small number of actuators relative to the hand device DOFs, which reduces weight and cost of the hand device, while simultaneously allowing more robust gripping capabilities by permitting high numbers of DOF.

The present invention is applicable to all manners of object manipulation (such as lifting, pulling and pushing), tool operation, bin-picking and packing operations. The present invention is also applicable to fixturing applications, where the gripper is adapted to fix a specific object.

The present invention system relates to a robotic hand. The robotic hand comprises a central hub (also referred to as “central palm” interchangeably). The robotic hand comprises a plurality of fingers, each connected to and extending from the central palm. Each finger comprises a fingertip drivable thereon. The robotic hand may be rotated by a robotic arm (according to one embodiment) or a dedicated actuator (according to another embodiment). According to a preferred embodiment, the plurality of fingers are all placed on an imaginary common plane, but other embodiments may include fingers not necessarily on the same plane.

As there are several objects to be manipulated that vary in size and shape, for a specific object, the fingertips need to be placed at specific locations along the fingers and at certain angles one from another, in order to retract on the specific object to grasp and manipulate it. Changing the configuration of the device hand comprises replacing the location of the fingertips such that they will be configured to grasp a specific object when retracted. The replacing of the fingertips location comprises:
Positioning the distance of each fingertip to a certain distance from the hand palm.
Positioning the angles of the fingers (sitting on a common imaginary plane and angularly displaceable thereon) one from the other (e.g. in relation to the palm).

To grasp an object, the object is first photographed (e.g. by a camera placed viewing an assembly line, or a camera on the robotic hand itself, or a camera on another external item, etc.). The present invention system comprises a control unit (also referred to herein as controller) comprising a processor. The controller is connected to the camera (or is in a remote communication connection with the camera). The controller (e.g. a PC) is configured to obtain the image and perform analysis on the obtained image of the object, e.g. perform a series of image processing actions to the image, and obtain an approximation of the shape of the object (for example, a polygon resembling the peripheral circumference of the object). Then, the controller calculates the desired positions of the fingertips in order to grasp and manipulate the object (when the hand is positioned to a dedicated location above the object). For example, the controller randomly samples different finger placements on the object's shape approximation perimeter and selects points that provide grasps with the highest quality. For any given set of fingertip placements there are many hand configurations. The controller determinates and selects one configuration that is easy to change into. The controller may carry out these stages (e.g., determining shape, sampling, determining fingertip configuration, etc.) by using programs such as MATLAB. An example of an imager/camera of the present invention capable of imaging and transferring the image to the controller is: Webcam. E.g., Logitech HD Webcam C270.

The robotic hand configuration is altered both in fingertip distance from the palm and finger angle relative one to another. Once the desired hand configuration is achieved the robotic hand can be used to grasp the object and manipulate it. This concept enables to adapt the hand to an object without sacrificing reliability.

In cases where several objects of the same shape are needed to be manipulated (e.g. a plurality of identical components on a manufacturing conveyer line) the system may be synced for grasping each of the identical components and the grasp and manipulation is just a matter of opening and closing the fingers without adjusting the system (of course the hand may be positioned and rotated such that the fingertips will be in the correct configuration for grasping). This is because a single actuator drives all of the fingertips to the same extent, inwards (proximally) or outwards (distally).

When a new object component is introduced, the system recognizes the need for a structure change. A new image is captured, a shape approximation (e.g., polygon) calculated, etc., and the robotic hand structure is rearranged (adjusted, reoriented) accordingly.

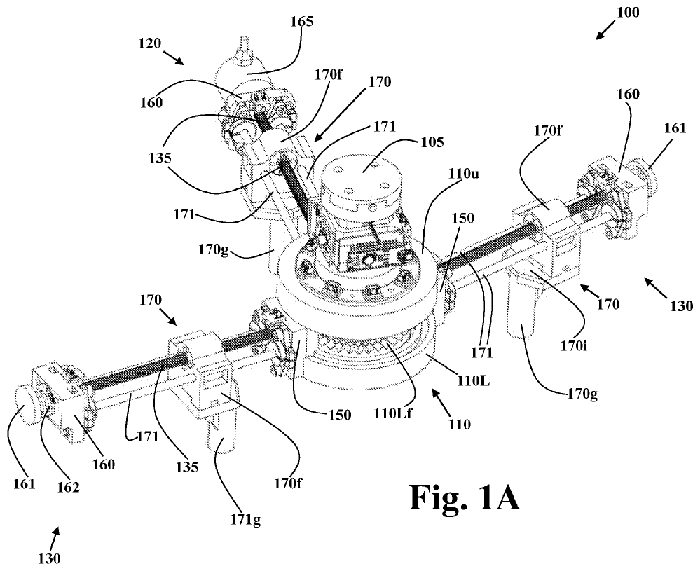

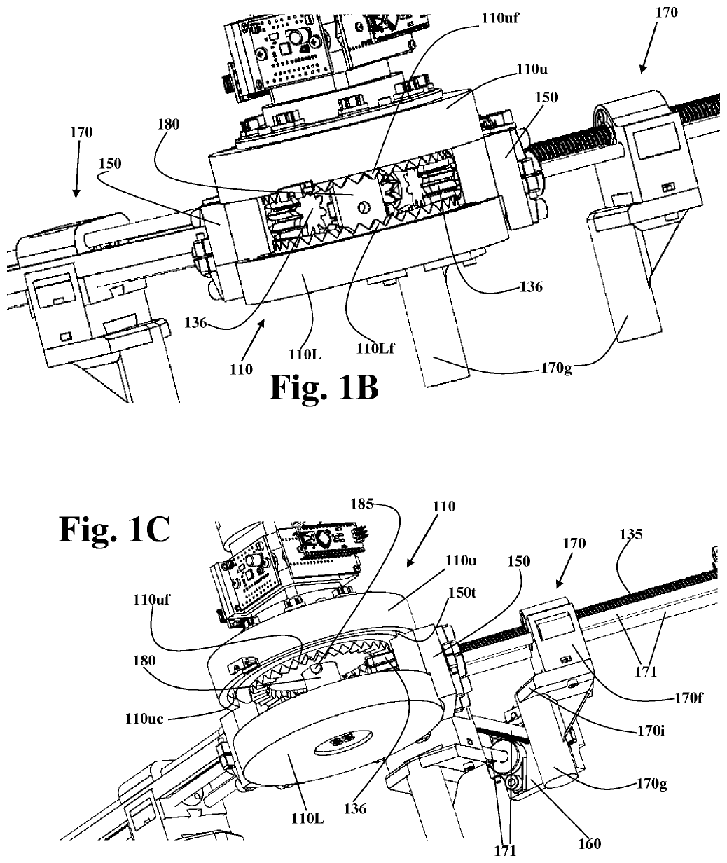

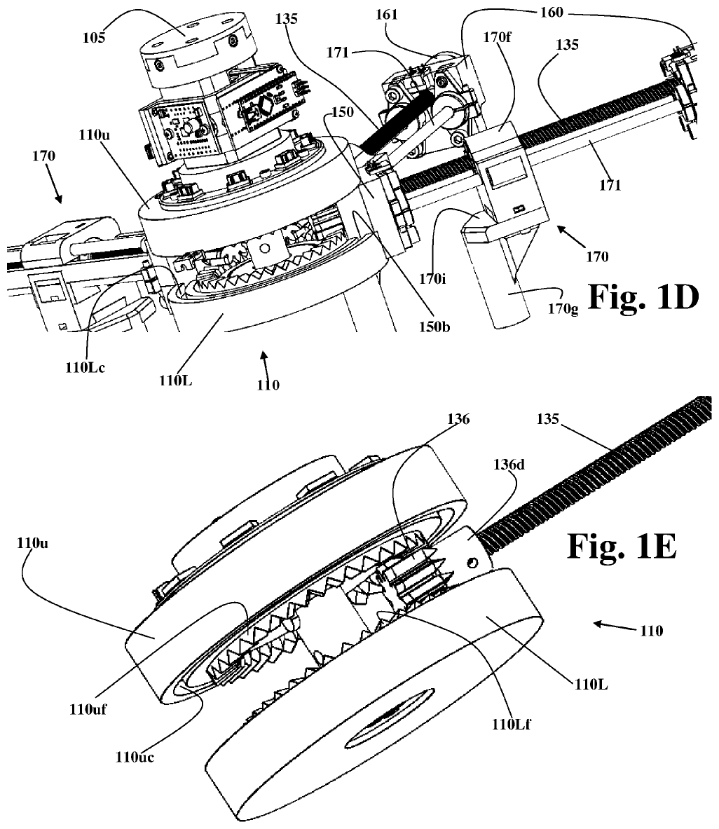

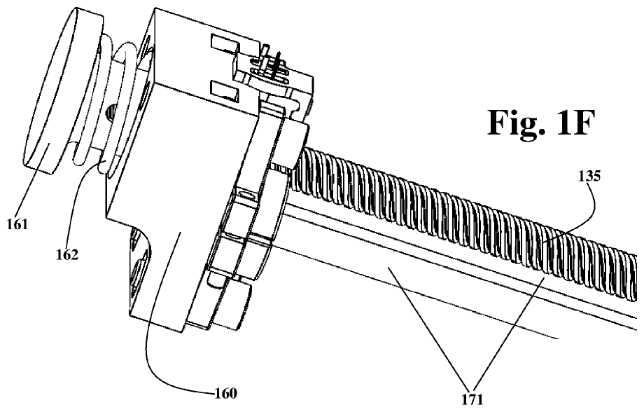

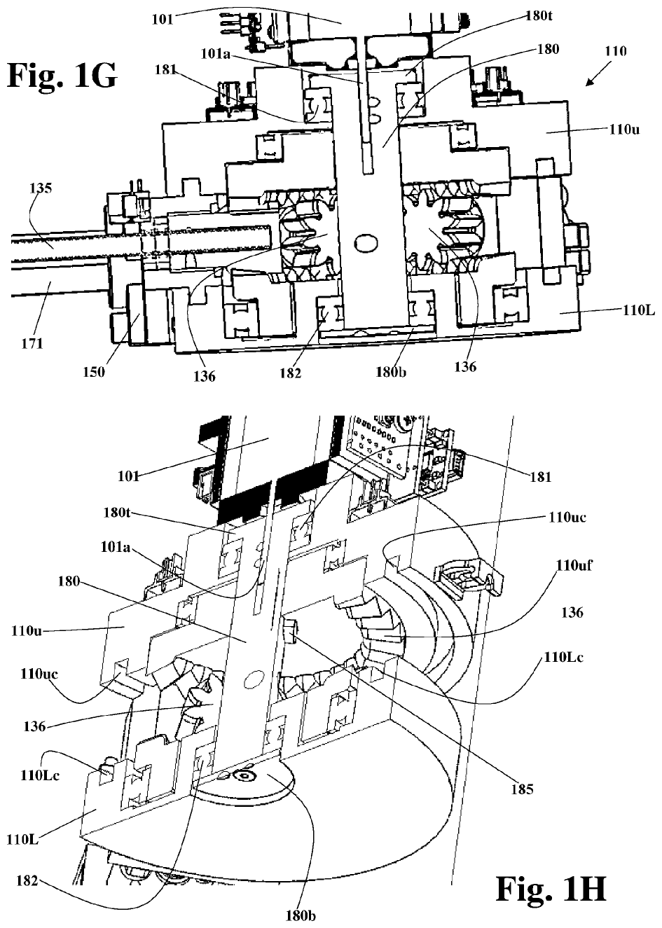

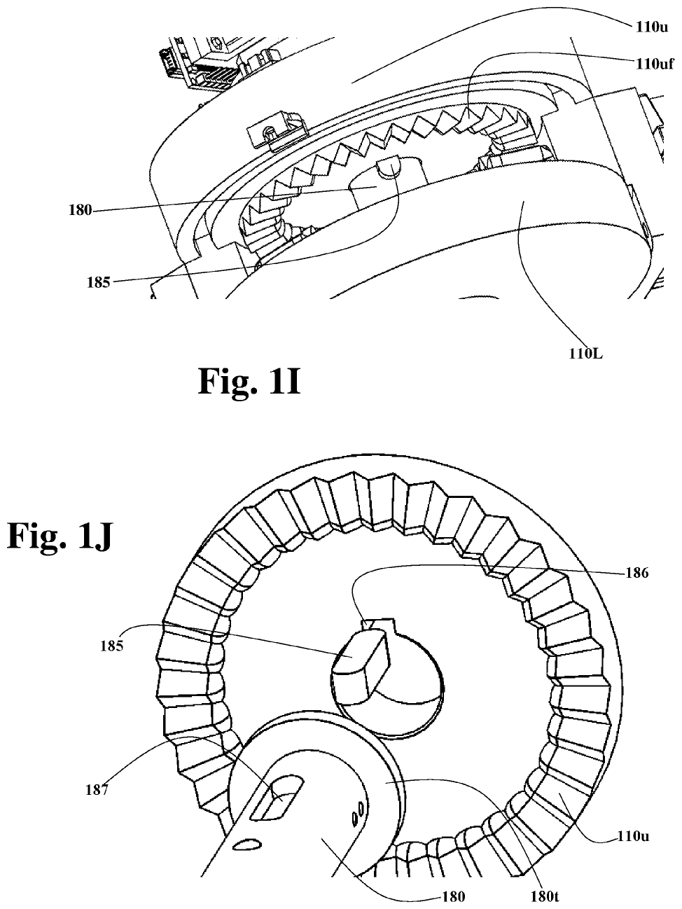

FIGS. 1A-1J show a preferred embodiment of the present invention robotic hand 100. The robotic hand 100 comprises a central palm 110. The robotic hand 100 comprises a plurality of fingers—a “thumb” finger 120 and two movable fingers 130, each connected to and extending from the central palm 110 (other embodiments may comprise fingers all of which are angularly displaceable). Each finger comprises a fingertip 170 drivable thereon (movable along itself). The robotic hand 100 may be rotated by a robotic arm (not shown), by means of the robotic arm being fixedly connected to an upper connection plate 105. The upper connection plate 105 (preferably circular) can be rotated by the robotic arm. The palm 110 comprises an upper housing plate 110u and a lower housing plate 110L (both of which are preferably circular). The upper housing plate 110u, lower housing plate 110L and upper connection plate 105 are fixed one to another such that a rotation movement of the upper connection plate 105 would necessitate a corresponding rotation of the upper housing plate 110u and lower housing plate 110L. Preferably, the central axis of the upper connection plate 105 is also that of the upper housing plate 110u and lower housing plate 110L.

The upper housing plate 110u comprises a face gear 110uf placed within a recess within the upper housing plate 110u, wherein the face gear 110uf is capable of rotating within the recess (see FIG. 1B). The lower housing plate 110L comprises a face gear 110Lf placed within a recess within the lower housing plate 110L, wherein the face gear 110Lf is capable of rotating within the recess.

The face gears 110Lf and 110uf are connected to the housing plates 110L and 110u respectively, by means of roller bearings therein (wherein the face gears 110Lf and 110uf are placed within the roller bearings that are placed within a dedicated recess within the respective plates 110L and 110u). FIGS. 1G-1H show cross-sections of the palm 110. The face gears 110Lf and 110uf are kept from moving upwards/downwards (towards the center of the hand) by the spur gears 136 of the fingers 120, 130. Preferably, the upper housing plate 110u is rigidly connected to lower housing plate 110L by one or more bolts that pass through the thumb finger 120 (through the proximal vertical surface 150).

According to an embodiment of the present invention, the robotic hand 100 comprises a motor 101 (shown in FIGS. 1G-1H) preferably placed within a housing somewhere between upper housing plate 110u and upper connection plate 105. The motor 101 is configured to drive and rotate face gear 110uf (or in other embodiments face gear 110Lf). The motor 101 comprises a spinnable axel 101a extending vertically downwards therefrom (e.g., a rotor).

The face gear 110uf is connected to the motor via a shaft 180 and key 185. The shaft 180 is placed at the center of palm 110 (passing through corresponding central bores within face gears 110uf and 110Lf). The shaft 180 is anchored to housing plates 110u and 110L through thrust bearings 181 and 182 respectively. The shaft comprises a top surface 180t (preferably having a disc form wider than the shaft 180 center) resting on thrust bearings 181. The shaft comprises a bottom surface 180b (preferably having a disc/plate form wider than the shaft 180 center) beneath thrust bearings 181 and engaging thrust bearings 181. The bottom surface 180b may be an independent item having a plate form connected to the shaft 180 main body portion by means of bolts (said plate prevents the bottom thrust bearing 181 from moving along the shaft axis). The thrust bearings 181, 182 are placed within respective recesses within the respective housing plates 110u and 110L. The thrust bearings 181, 182 enable the rotation of shaft 180 with low friction.

The spinnable axel 101a is rigidly connected to shaft 180. According to one embodiment the spinnable axel 101a is rigidly connected to shaft 180 by means of bolts. According to another embodiment, the spinnable axel 101a comprises one or more side protrusions protruding sideways therefrom into corresponding complementary recesses within shaft 180. In any case, the connection between shaft 180 and axel 101a is firm such that when axel 101a rotates, it causes shaft 180 to rotate accordingly. The shaft 180 is connected to face gear 110uf by means of a shaft and key mechanism shown in FIGS. 1I-1J. Shaft 180 comprises a keyseat 187. Face gear 110uf comprises a keyway 186 along its central bore. A key 185 is placed partially within keyseat 187 and partially within keyway 186. FIG. 1J shows the key 185, keyseat 187 and keyway 186 in an explosion view. Thus, when shaft 180 rotates (by motor axel 101a of motor 101), the key 185 (seated within keyseat 187 and keyway 186) also rotates forcing face gear 110uf to rotate accordingly. Thus, the spur gears 136 rotate accordingly (and face gear 110Lf also rotates in the opposite direction of face gear 110Lf accordingly). In other embodiments, the key-keyway-keyseat are positioned connecting to the lower housing plate 110L, mutatis mutandis.

According to an embodiment of the present invention, upper connection plate 105 is connected to the motor 101 (e.g., by bolts). The motor 101 is connected to upper housing plate 110u (e.g., by bolts).

The thumb finger 120 and movable fingers 130 are all placed on an imaginary common plane. Fingers 130 are angularly displaceable on the imaginary common plane. More specifically, the fingers' 130 central lead screws 135, explained hereinafter, are all placed on a common imaginary plane and the lead screws 135 of the movable fingers 130 are angularly displaceable on the imaginary plane. The thumb finger 120 is stationary, i.e., it is not angularly displaceable. The thumb finger 120 and movable fingers 130 extend radially from the palm 110.

For obtaining a better understanding of the present invention, the fingers will be explained as follows. For each single finger (120, 130) the proximal direction is the horizontal moving direction when closing on an object to be grasped, i.e. the direction towards the center of palm 110. The distal direction is opposite to the proximal direction, i.e. the direction away from the center of palm 110.

According to a preferred embodiment, each of the fingers comprises a lead screw and follower mechanism. Each finger (120, 130) comprises a rotatable lead screw 135 along its length. The fingertips 170 each comprise an upper follower vertical surface member 170f and lower object engaging/grasping member 170g (configured to engage and then grasp, the object to be manipulated). The lower object engaging/grasping member 170g extends vertically downwards from the upper follower vertical surface member 170f. Optionally, an intermediate surface 170i attached to and between both the lower object engaging/grasping member 170g and the upper follower vertical surface member 170f, provides a distance offset between them. In FIG. 1A the offset is shown to be proximally, i.e. the lower object engaging/grasping member 170g extends downwards from the intermediate surface 170i at a location proximal to the upper follower vertical surface member 170f. Other embodiments may have the offset in the opposite direction, mutatis mutandis. The controller calculations of the fingertip positioning as explained herein preferably take the offset into account when processing and adjusting. Preferably, the lower object engaging/grasping element 170g is cylindrical.

The lead screw 135 passes through the upper follower vertical surface member 170f via a follower element. The follower element and the lead screw 135 form the lead screw and follower mechanism. Each finger (120, 130) comprises a proximal vertical surface 150 near its proximal end and a distal vertical surface 160 near its distal end (wherein the lead screw 135 passes through both via an aperture passageway). Each finger (120, 130) preferably comprises one or more rods 171 fixed between proximal vertical surface 150 and distal vertical surface 160. The one or more rods 171 also pass through the upper follower vertical surface member 170f. The upper follower vertical surface member 170f is movable between the proximal vertical surface 150 and the distal vertical surface 160 by the lead screw and follower mechanism.

The two rods 171 provide structural support and torque resistance (e.g., preventing fingertip 170 from rotating). The rods 171 are rigidly attached to proximal vertical surface 150 and distal vertical surface 160, creating a rigid rail. The upper follower vertical surface member 170f comprises linear bearings therewithin such that the rods 171 that pass therethrough slide along the linear bearings. The upper follower vertical surface member 170f houses the follower element, i.e. a screw follower (a nut) that is rigidly attached to it, so that when the lead screw 135 rotates inside the follower it forces the follower vertical surface member 170f (and thus the entire fingertip 170) to move linearly (distally or proximally depending on the rotation direction) along the respective finger 120, 130, lead screw 135 and rails 171.

The upper housing plate 110u bottom portion comprises a peripheral channel 110uc (preferably circular) placed around the face gear 110uf (see FIG. 1C). The lower housing plate 110L top portion comprises a peripheral channel 110Lc (preferably circular) placed around the face gear 110Lf (see FIG. 1D). The proximal vertical surface 150 comprises a top protrusion 150t and bottom protrusion 150b placed inside the peripheral channels 110uc and 110Lc respectively, such that a track is formed. Thus, this enables the respective finger to be angularly displaceable (from the center of palm 110), by having surface 150 movable along the tracks 110uc and 110Lc. According to an embodiment of the present invention, thumb finger 120 is angularly stationary, as will be explained herein.

The lead screw 135 of each finger passes through the proximal vertical surface 150. The rotatable lead screw 135 comprises a spur gear 136 fixedly attached to its proximal side (placed proximally to the proximal vertical surface 150). The spur gear 136 meshes with face gear 110uf and with face gear 110Lf, such that when face gear 110uf rotates it causes spur gear 136 (and thus lead screw 135) to rotate (it causes the lead screws 135 of all of the fingers to rotate). Face gear 110Lf rotates in the opposite direction of face gear 110uf accordingly. When lead screw 135 rotates in a certain direction, the fingertip 170 moves distally. When lead screw 135 rotates in the opposite direction, the fingertip 170 moves proximally. The system is structured such that the face gear 110uf causes the lead screws 135 (of all of the fingers) to always rotate in the same direction and thus all fingertips 170 move proximally at the same time, or all fingertips 170 move distally at the same time. The motor is configured to rotate face gear 110uf in both directions, and thus cause fingertip 170 to either move distally or proximally. The motor is connected to the system controller and when adjusting the hand (or grasping an object) the controller causes movement of the fingertip 170 according to the requested action.

The two movable fingers 130 each comprise a plunger mechanism incorporated with a “clutch” mechanism. The lead screw 135 comprises a distal driving element 161 (which is a distal plunger surface, also referred to herein as “distal plunger surface 161”) fixedly attached to its distal side (see FIG. 1F). The two movable fingers 130 each comprise a plunger spring 162 placed between the distal plunger surface 161 and the distal vertical surface 160 (or an inner surface within a recess in distal vertical surface 160). Preferably, the plunger spring 162 is a coil spring wherein the lead screw 135 passes therethrough. The plunger spring 162 is compressed between the distal plunger surface 161 and the distal vertical surface 160 and constantly tends to expand, thus applying force to the distal side of distal vertical surface 160 and to the proximal side of distal plunger surface 161.

As said, in a normal state, the fingers are in a mode such that the spur gear 136 meshes with face gear 110uf and with face gear 110Lf. However, when an external force pushes the distal plunger surface 161 proximally, it causes the entire lead screw 135 and thus spur gear 136 to move proximally. This causes the spur gear 136 to move proximally within the interior of face gears 110Lf and 110uf (decoupling from the state of meshing with them) such that spur gear 136 no longer meshes with face gears 110Lf and 110uf. In this manner, fingers 130 may be angularly displaceable. When the external force ceases, the plunger spring 162 pushes the distal plunger surface 161 distally (and thus lead screw 135 distally) and thus the spur gear 136 remeshes with face gear 110uf and with face gear 110Lf. Preferably, the spur gear 136 (shown in FIG. 1E) comprises a distal portion 136d (thicker than the passageway that lead screw 135 passes through) which is engageable with the proximal side of proximal vertical surface 150 (i.e., the area around the passageway that lead screw 135 passes through; or an inner surface within a recess in proximal vertical surface 150 around the passageway that lead screw 135 passes through), such that the lead screw 135 will move distally until distal portion 136d engages said proximal side or said inner surface. Alternatively, a toggle mechanism (not shown) can be used, so that a single press of a plunger disengages the spur gear from the face gears, and a second press of the plunger remeshes the spur gear with the face gears.

The thumb finger 120 may not comprise the plunger mechanism, as it is sufficient that the fingertips may be placed in any configuration with moving the fingertips and angularly displacing fingers 130 only. Also, the angles between the fingers may be calculated in relation to thumb finger 120. Therefore, thumb finger 120 may just terminate at its distal vertical surface 160. According to one embodiment, an optical rotary encoder 165 is attached to the distal side of distal vertical surface 160. Thus, the spur gear 136 of thumb finger 120 always remains meshing with face gear 110uf and with face gear 110Lf. It should be noted that all of the portions in thumb finger 120 proximal to distal vertical surface 160 may be the same as in movable fingers 130.

This configuration is very advantageous as it enables to displace the fingertips 170 to be in the required location prior to grasping. For example, in a Polar Coordinate System three fingertips 170 can be placed at any required location on the Polar Coordinate System.

### Example 1

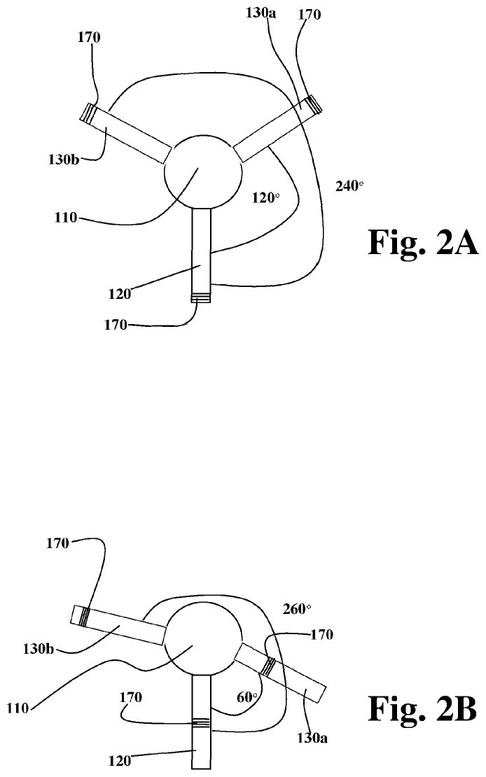

In the following example, FIG. 2A shows a cross section view of a first location scenario of the fingertips and FIG. 2B shows a cross section view of a second location scenario. FIG. 2A shows the thumb finger 120 at zero degrees, the movable finger 130a at 120 degrees and the movable finger 130b at 240 degrees. The fingertips being at their most distal ends (where for the sake of simplicity of the example the most distal end is regarded as distance 10 and the most proximal as distance zero), i.e. at distance 10. The following table shows the changing stages of this example:

TABLE 1

| | Thumb | | Finger | | Finger | |
|---|---|---|---|---|---|---|
| | 120 | Thumb | 130a | Finger | 130b | Finger |
| | fingertip | 120 | fingertip | 130a | fingertip | angle |
| Stage | distance | angle | distance | angle | distance | 130b |
| Stage 1 | 10 | 0 | 10 | 120 | 10 | 240 |
| (FIG. | | | | | | |
| 2A) | | | | | | |
| Stage 2 | 6 | 0 | 6 | 120 | 10 | 260 |
| Stage 3 | 4 | 0 | 4 | 120 | 8 | 240 |
| Stage 4 | 5 | 0 | 4 | 60 | 9 | 240 |
| (FIG. | | | | | | |
| 2B) | | | | | | |

All of the adjusting stages are controlled by the controller. At first, the plunger mechanism of finger 130b is applied and disengages the spur gear 136 from meshing with the face gears 110Lf and 110uf. This is carried out by the system arm connected to the hand 100 at upper connection plate 105. The system arm manipulates the hand 100 and pushes the distal plunger surface 161 of finger 130b towards an environment item (e.g. a wall, the system arm body) compressing its distal plunger surface 161 inwards disengaging the spur gear 136 from meshing with the face gears 110Lf and 110uf. The motor is activated and drives the fingertips 170 of thumb 120 and finger 130b from distance 10 to distance 6.

The angular calculation shifting between the fingers herein is calculated in relation to the thumb finger 120 (the entire hand may angularly change in the process but the relative angles between the fingers remains unless shifted by the plunger).

Then the system arm rotates upper connection plate 105 (and thus entire hand 100) clockwise by 20 degrees. As the plunger system of finger 130b is pressed, the finger 130b stays in place and the angle between it and thumb 120 enlarges to 260 degrees. Then, the arm pushed the hand 100 away from the environment item and the plunger mechanism returns the finger 130b back to normal. The spring expands and pushes its corresponding distal plunger surface 161 distally, thus the spur gear 136 remeshes with face gear 110uf and with face gear 110Lf. The system then retracts all three fingertips 120, 130a and 130b by two distances, i.e. from distances 6, 6 and 10 respectively to distances 4, 4 and 8 respectively.

Then, the system arm manipulates the hand 100 and pushes the distal plunger surface 161 of finger 130a towards an environment item (e.g. a wall, the system arm body) compressing its distal plunger surface 161 inwards disengaging the spur gear 136 from meshing with the face gears 110Lf and 110uf. The motor is activated and drives the fingertips 170 of thumb 120 and finger 130b from distances 4 and 8 respectively to distances 5 and 9 respectively.

Then the system arm rotates upper connection plate 105 (and thus entire hand 100) counterclockwise by 60 degrees. As the plunger system of finger 130a is pressed, the finger 130a stays in place and the angle between it and thumb 120 lessens to 60 degrees (120−60=60). Then, the arm pushed the hand 100 away from the environment item and the plunger mechanism returns the finger 130a back to normal. The spring expands and pushes its corresponding distal plunger surface 161 distally, thus the spur gear 136 remeshes with face gear 110uf and with face gear 110Lf. Thus, the hand is in the position of FIG. 2B (stage 4 in table 1) and ready to perform a grasp of a certain object. The system arm positions the hand (e.g. the palm 110) above the certain object (e.g., by means of the control unit) in position for grasping and manipulating (with the palm 110 above the object and the fingers' engaging/grasping members 170g at the same height level as the object).

The present invention hand 100 may include embodiments with additional (or less) movable fingers 130, mutatis mutandis.

### Example 2

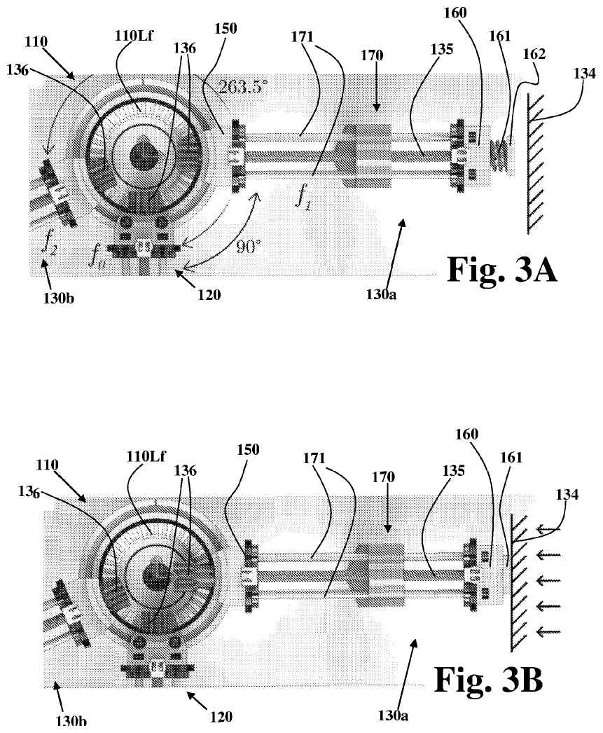

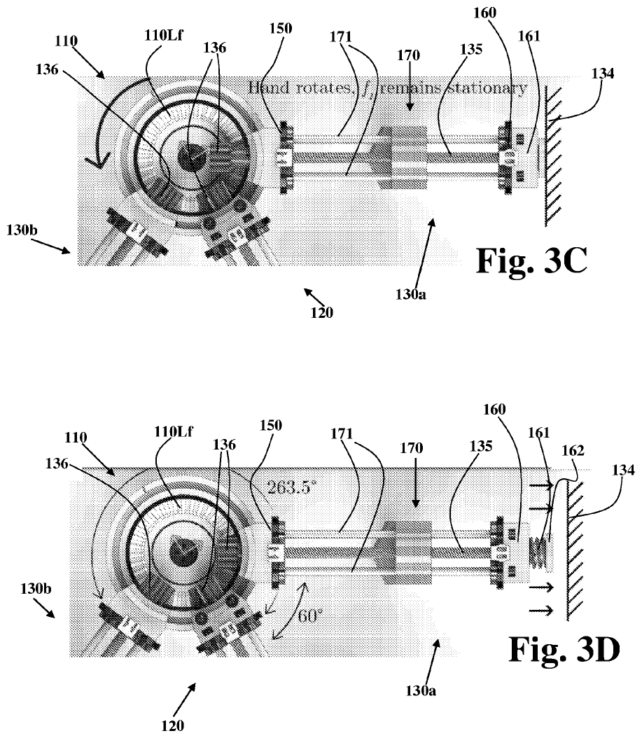

The following example particularly shows the clutch mechanism of the present invention. FIGS. 3A-3D show the change of a relative finger angle, shown as a partial section view (top part of the hand 100 is now shown). FIG. 3A shows an initial state, where the angle between a first finger 130a and the thumb finger 120 is 90 degrees, and the angle between a second finger 130b and the thumb 120 is 263.5 degrees. All of the fingers' spur gears mesh with the face gears, as explained herein.

FIG. 3b shows the finger 130a pressed against an environment item, in this case a wall 134, and the plunger mechanism is activated. When the distal plunger surface 161 is pressed proximally by the wall 134 (actually the finger 130a is moved distally causing this), the spur gear 136 connected to the lead screw 135 disengages from the round face gears 110Lf and 110uf (only face gear 110Lf is shown in FIGS. 3A-3D) in palm 110.

In FIG. 3C the hand 100 is rotated (e.g. by the system arm connected to upper connection plate 105) by 30 degrees counterclockwise. The pressed finger 130a remains stationary, since it is not connected to the palm face gears and the angle between the thumb 120 and finger 130a is now 60 degrees. FIGS. 3B and 3C show finger 130a pressed inwards (proximally), with the spur gear 136 placed proximally, within the interior of the circular face gear 110Lf. Since in this stage there is no meshing between the gears constraining them in place, the finger 130a is capable of being angularly displaceable.

In FIG. 3D the plunger mechanism is released (the system arm manipulates the hand 100 away from wall 134), the plunger spring 162 of finger 130a pushes the distal plunger surface 161 distally (and thus lead screw 135 distally) and thus the spur gear 136 remeshes with the face gears 110uf and 110Lf. The hand 100 fingers are now angularly stationary with the angle between finger 130a and the thumb 120 being 60 degrees and the angle between finger 130b and the thumb 120 remaining 263.5 degrees.

### Example 3

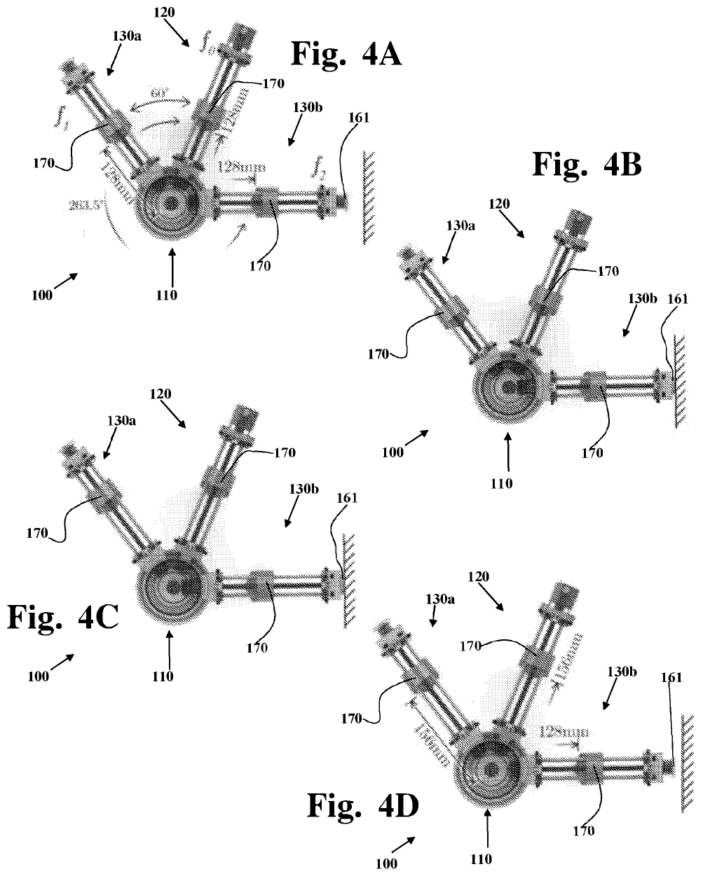

The following example particularly shows the clutch mechanism of the present invention with a relative distance change of the fingertips 170. FIGS. 4A-4D show the change of a relative distancing shown as a partial section view (top part of the hand 100 is now shown). FIG. 4A shows an initial state of hand 100, where the distance between all of the fingertips 170 (of thumb 120, finger 130a and finger 130b) and the center of palm 110 is 128 mm. All of the fingers' spur gears mesh with the face gears, as explained herein.

FIG. 4b shows the finger 130b pressed against an environment item, in this case a wall 134, and the plunger mechanism is activated. When the distal plunger surface 161 is pressed proximally by the wall 134 (actually the finger 130b is moved distally causing this), the spur gear 136 connected to the lead screw 135 disengages from the round face gears 110Lf and 110uf (only face gear 110Lf is shown in FIGS. 4A-4D) in palm 110.

In FIG. 4C the hand 100 motor dives the face gear 110uf in a manner such that the screw and follower mechanism drives the fingertips away from the center of the palm 110 (distally). The pressed finger 130b fingertip 170 remains stationary, since the spur gear 136 of finger 130b is not connected to the palm 110 face gears. FIGS. 4B and 4C show finger 130b pressed inwards (proximally), with the spur gear 136 placed proximally, within the interior of the circular face gear 110Lf. Since in this stage there is no meshing between the gears, the fingertip 170 of finger 130b remains stationary and does not move. However, the fingertips 170 of thumb 120 and finger 130a are moved 28 mm distally.

In FIG. 4D the plunger mechanism is released (the system arm manipulates the hand 100 away from wall 134), the plunger spring 162 of finger 130a pushes the distal plunger surface 161 distally (and thus lead screw 135 distally) and thus the spur gear 136 remeshes with the face gears 110uf and 110Lf. The hand 100 fingertips are such that the fingertips 170 of thumb 120 and finger 130a are at a distance of 156 mm from the center of palm 110, and the fingertip 170 of finger 130b remains at a distance of 128 mm from the center of palm 110.

Thus this embodiment provides a robotic gripping device hand 100 with a single actuator.

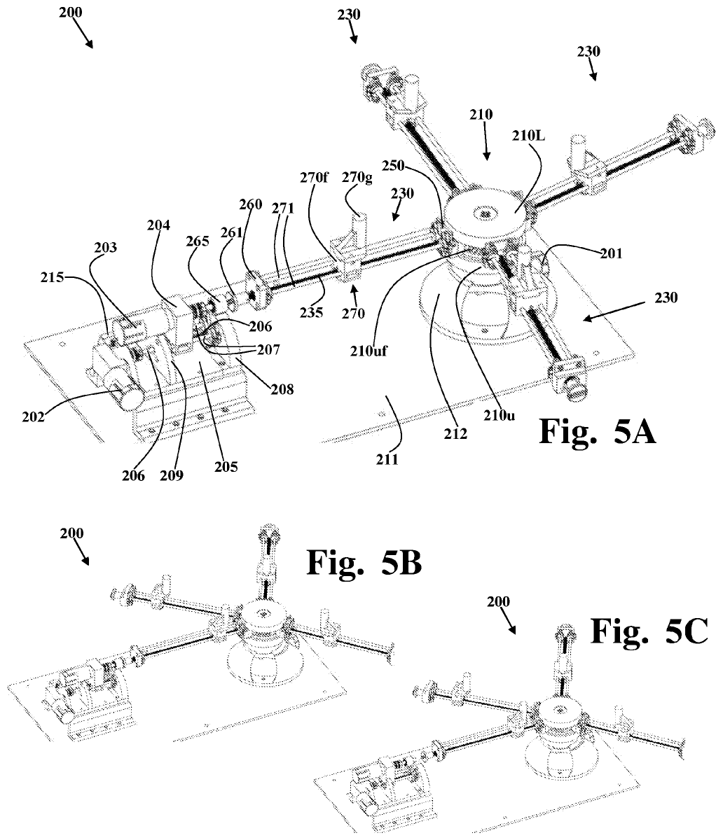

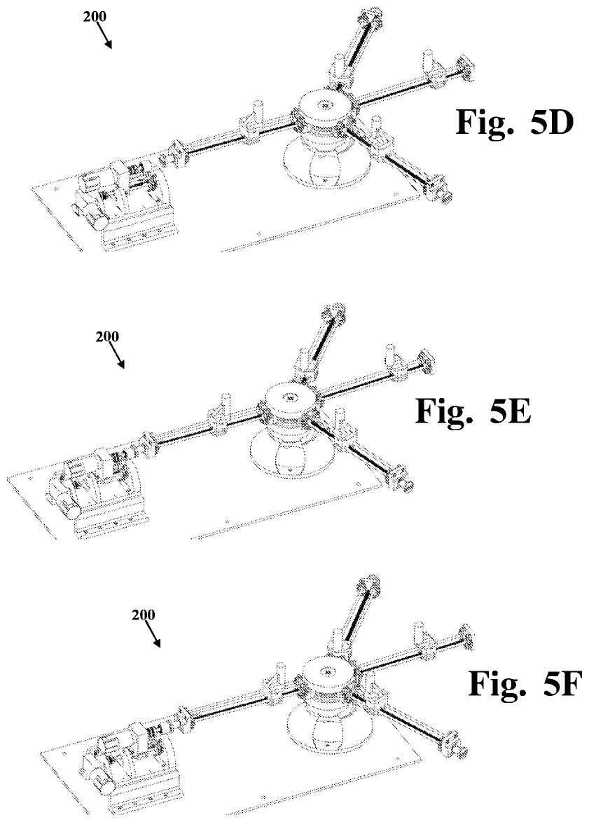

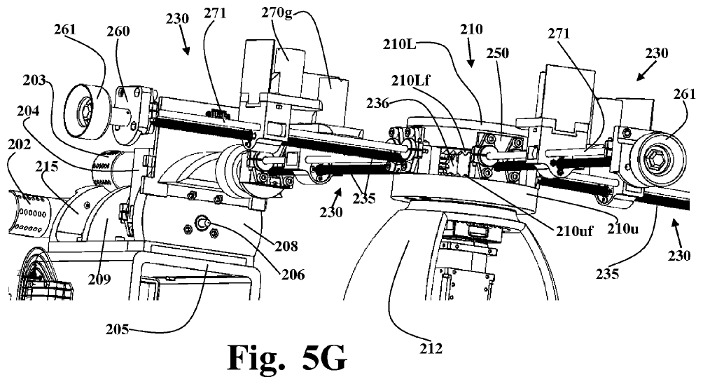

According to another embodiment, the present invention comprises a hand 200 comprising a palm 210 mounted on a flat surface 211 (e.g. a flat plate), as shown in FIGS. 5A-5G. The hand 200 is shown upside-down with the fingertips extending downwards but are shown to extend “upwards” in these upside-down figures. Many components of hand 200 are similar to those of hand 100. Elements 110, 110u, 110L, 110uf, 110Lf, 110uc, 110Lc, 135, 136, 136d, 150, 150t, 150b, 170, 170g, 170f, 170i, 171 and 160 are similar to corresponding elements 210, 210u, 210L, 210uf, 210Lf, 210uc, 210Lc, 235, 236, 236d, 250, 250t, 250b, 270, 270g, 270f, 270i, 271 and 260 in hand 200 respectively. The gear meshing is also similar, mutatis mutandis. The proximal and distal directions are also the same. All of the fingers of hand 200 sit on a common imaginary plane and are angularly displaceable thereon. The hand 200 of this embodiment comprises three motors but provides eight DOF. Prior art devices would usually necessitate 8 separate motors to drive this configuration to independently control the 8 DOF, but the present invention sequential arrangement provides reduction of the number of actuators used.

In this embodiment, there is no motor that spins the face gear 210Lf (and no elements connecting a motor to the central shaft, mutatis mutandis). The gears are driven in a different manner as will be explained herein. In this embodiment, there is no plate 105. In this embodiment, there are no elements connecting a motor to a central shaft. FIGS. 5A-5G show the hand 200 comprising four angularly displaceable fingers 230, angularly displaceable on the common imaginary plane that they sit on. Other embodiments may include a thumb finger fixed to housing plates 210u and 210L (with the fingertips movable thereon but without being capable of being displaced angularly similarly to thumb 120, mutatis mutandis). Other similar embodiments may comprise more or less fingers.

As said, the finger elements of finger 230 are similar to those explained in relation to finger 130 (e.g. some embodiments do not necessarily have a plunger spring like element 162). The fingers 230 comprise a distal driving element 261 similar to the function of distal plunger surface 161 (but may have a structure that assists its rotation, as will be explained herein). The distal driving element 261 may comprise a hollow cylindrical element with an interior protrusion, or have a distal surface with means for connecting to an external manipulator for being manipulated (e.g. rotated, pushed, pulled). The driving element 261 is fixedly connected to the lead screw 235 and when it rotates, the lead screw 235 rotates accordingly.

The palm 210 of hand 200 is connected to surface 211 by being mounted on base 212 that is mounted on surface 211 (or it is mounted directly on surface 211). Hand 200 comprises three motors. The first motor 201 is mounted near palm 210 (e.g. on base 212 or directly on surface 211) configured to rotate palm 210 (with all its connected fingers). The motor shaft (e.g. rotor, axel extending therefrom) is rigidly attached to the housing plate 210u, such that when it spins it spins the housing plate 210u accordingly. The motor body is preferably rigidly attached to the base 212.

The second motor 202 is configured to linearly move an engaging member 265 distally or proximally. The engaging member 265 is configured to engage the distal driving element 261 and move it distally or proximally and also configured to rotate it.

Hand 200 comprises a horizontal lower descended surface 205 connected to surface 211 and substantially parallel to surface 211 (because FIGS. 5A-5G show hand 200 upside-down it looks like an elevated surface). This is in order to adapt the engaging member 265 to the height of the hand 200 fingers (height meaning the distance from surface 211). The descended surface 205 comprises a distal vertical bearing surface 209 extending vertically therefrom and a proximal vertical bearing surface 208 extending vertically therefrom (both extending vertically downwards; shown upwards in the upside-down hand FIGS. 5A-5G). Motor 202 is configured to drive a lead screw 206 and operate a lead screw and follower mechanism. Hand 200 comprises a bearing 204 (e.g. having a cuboid shape). The bearing 204 is also referred to herein as bearing member 204. The bearing 204 is also the screw follower of the lead screw and follower mechanism. Bearing 204 is configured to move proximally and distally and is placed between the two vertical surfaces 208 and 209. Bearing 204 upper portion (shown in the upside-down configuration as “lower”) comprises a “follower” element of the mechanism (a nut) that the lead screw 206 passes through. The lead screw 206 also passes through distal vertical bearing surface 209 connecting to motor 202. The bearing 204 “follower” member is rigidly in contact with the lead screw 206 such that when the lead screw 206 rotates inside the “follower” element (driven and rotated by motor 202) it forces the bearing 204 to move linearly distally or proximally depending on the rotation direction of lead screw 206 of the lead screw and follower mechanism. The hand 200 further comprises one or more rails 207 (e.g. rods), connected between the two vertical surfaces 208 and 209. The rails 207 pass through the bearing 204 (preferably near its sides) thereby providing structural support and torque resistance to the bearing 204 when in motion.

The third motor 203 is rigidly connected to bearing 204 (mounted thereon), and thus they are both traversed proximally or distally by motor 202. The third motor 203 is connected to engaging member 265 and configured to rotate and spin engaging member 265 in both directions (e.g., the engaging member 265 is connected to an axel extending proximally from motor 203 where motor 203 drives the axel and causes it to spin). Thus, motor 202 causes engaging member 265 to move distally and proximally and motor 203 causes engaging member 265 to rotate.

The motor 203 is mounted on bearing 204 at a location such that the engaging member 265 (connected to the spinning axel) may be aligned and engageable with driving element 261 of each finger 230.

The motor 202 is placed at a distance from palm 210 that is well greater than the length of the fingers 230 to enable bearing 204 (placed proximally from motor 202) to move distally and proximally. Motor 202 may be mounted on a vertical surface 215 extending vertically from surface 205.

Engaging member 265 is preferably a universal socket. The distal driving element 261 preferably comprises a protrusion compatible with the engaging member 265 (i.e. compatible with a portion of engaging member 265 e.g. the protrusion may be a hexagonal protrusion). When the engaging member 265 is pressed against the distal driving element 261 (e.g. engaging the hexagonal protrusion) it can rotate it. It moves the finger proximally by pushing it inwards (motor 202) against a coil spring (just like the plunger was pressed in the embodiment of finger 100). It moves the finger distally by retreating distally, allowing the coil spring to expand and return the finger to its default position. The default position is when the spur gear 236 distal portion 236d (thicker than the passageway that lead screw 235 passes through) engages the proximal side of proximal vertical surface 250 (i.e., the area around the passageway that lead screw 235 passes through; or an inner surface within a recess in proximal vertical surface 250 around the passageway that lead screw 235 passes through), similarly to as described in relation to distal portion 136d of hand 100, mutatis mutandis.

The motor 202 may linearly displace the bearing 204 such that the engaging member 265 may be in 3 positions. The first position is where the engaging member 265 is at its most distal position (furthest from palm 201). In this position the motor 201 may spin the palm 210 without the fingers colliding with engaging member 265 of fingers 230.

The second position is where the motor 202 has pushed bearing 204 and thus engaging member 265 proximally such that engaging member 265 connects to a specific finger distal driving element 261 (the specific finger referred to as the connecting finger). The connecting finger has previously been angularly displaced by motor 201 such that it is now pointed to the engaging member 265 (and aligned with the direction of the engaging member 265 extending from motor 203). In this position motor 203 spins the distal driving element 261 causing the spinning of lead screw 135 and thus of spur gear 236. The spinning of spur gear 236 that meshes with face gears 210Lf and 210Lc, causes face gears 210Lf and 210Lc to rotate (each at a different corresponding direction) which cause the other spur gears 236 of hand 200 to rotate. This activates the lead screw and follower mechanisms of all of the fingers in hand 200, which moves all of the corresponding fingertips 270 distally or proximally, depending on the spinning direction that motor 203 drives. All of the fingertips 270 move distally (away from palm 210) or proximally (towards palm 210) depending on the face gears rotation direction (where all of the fingers' spur gears 236 mesh similarly with the face gears 210Lf and 210Lc).

In the third position the motor 202 pushes the bearing 204 and thus engaging member 265 to its most proximal direction such that the connecting finger's spur gear 236 disengages from meshing with the face gears 210Lf and 210uf and is placed within the interior of the circular face gears 210Lf and 210uf. In this third position the connecting finger may be angularly displaced in relation to the other fingers. The engaging member 265 (pushing on driving element 261) holds the connecting finger in place while motor 201 rotates palm 210 (with all the other hand 200 fingers) until the required angle between the connecting finger and the other fingers, is achieved. Also, in this third position the motor 203 may spin the engaging member 265 which spins the connecting finger distal driving element 261 and moves only the fingertip 270 of the connecting finger distally or proximally. As the connecting finger spur gear 236 is not in a meshing position with the face gears, when the connecting finger lead screw 235 spins this affects only the connecting finger fingertip 270 positioning and not the positioning of the other fingertips 270 of hand 200. This third position enables the adjustment of the angle of the connecting finger (in relation to the other hand 200 fingers) and enables the adjustment of the position of the connecting finger fingertip 270 (in relation to the other fingertips). After the connecting finger angle adjusting and/or the position adjusting of the connecting finger fingertip 270 (in relation to the other fingertips) is completed, the engaging member 265 moves distally and the spring of the connected finger pushes the driving element 261 back distally and thus the lead screw 235 moves distally and the connecting finger spur gear 236 remeshes with face gears 210Lf and 210uf. Then the engaging member 265 moves further distally disengaging from the connecting finger distal driving element 261.

FIG. 5A shows a stage where the engaging member 265 is at a distal position. FIG. 5B shows a stage where the engaging member 265 is in the third position (as explained above) disengaging the meshing of the connecting finger spur gear 236 from the palm face gears 210Lf and 210uf. The motor 201 spins the palm 210 counterclockwise (when looked on from above, as the hand 200 is shown upside-down; if the hand would be positioned not upside-down then the spinning would be seen clockwise) and the angle between the connecting finger and the other fingers is changed. FIG. 5C shows the engaging member 265 moved to its first position (by motor 202), i.e. to its most distal position (furthest from palm 210). FIG. 5D shows the palm 210 rotated clockwise (when looked on from above as explained above) until the former connected finger's next adjacent finger is in position to connect to engaging member 265. FIG. 5E shows the engaging member 265 moving to the second position where motor 203 is capable of causing all of the fingertips 270 in hand 200 to move simultaneously. FIG. 5F shows the engaging member 265 in the second position after all of the fingertips 270 have been retracted (proximally) a certain distance. FIG. 5G shows a different angle of hand 200 (and a slightly different version from the previous ones), particularly seeing elements 236, 210Lf and 210uF.

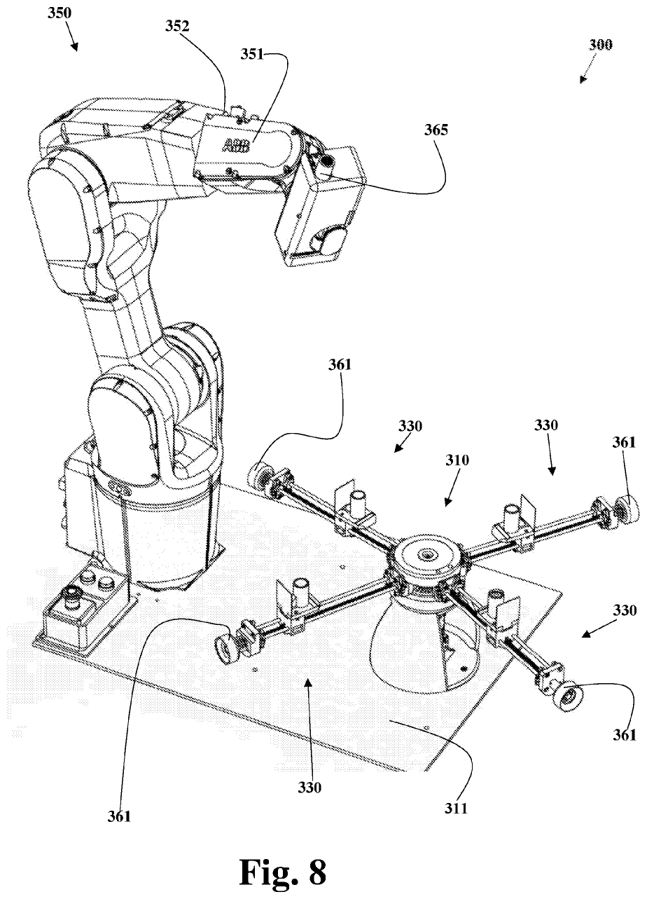

FIG. 8 shows yet another embodiment of the present invention. According to this embodiment, the present invention comprises a hand 300 comprising a palm 310 mounted on a flat surface 311. All of the components of the palm 310 (including the motor), and the hand 300 fingers 330 are similar to those of the corresponding hand 200, except for that the engaging member 365 is connected to the end of a robotic arm 350 mounted on and attached to flat surface 311 (used instead of the two motors 202 and 203 and other driving components and accessories that assist in driving engaging member 265 in hand 200). For the sake of brevity and simplicity the equivalent elements will not be explained in detail. The hand 300 is shown upside-down with the fingertips extending downwards but are shown to extend “upwards” in this upside-down figure. The robotic arm 350 comprises a plurality of segments and revolute joints between segments. One or more motors may drive the robotic arm 301 rotating a segment in relation to its adjacent segment by the revolute joint therebetween.

The engaging member 365 (that may be similar to engaging member 265 as explained herein) is engageable with the distal driving elements 361 of the fingers 330. The revolute joints enable the arm 350 to move the engaging member 365 distally and proximally, thereby enabling the displacing of the distal driving element 361 distally or proximally (thereby applying the plunger effect, etc.). the robotic arm comprises a rotatable segment 351 (its rotating joint 352 that it is connected to enables it to rotate). This enables the engaging member 365 to rotate (at a certain position) and thereby enables rotating the distal driving element 361, the corresponding lead screw, driving the corresponding fingertips distally/proximally, as explained in detail herein, mutatis mutandis. In other embodiments, an internal motor (e.g., within the segment that the engaging member 365 is connected to) may rotate the engaging member 365, mutatis mutandis. Other segment joint connections may also be carried out (e.g., telescopic mechanism, pneumatic or electric cylinder approach, etc.).

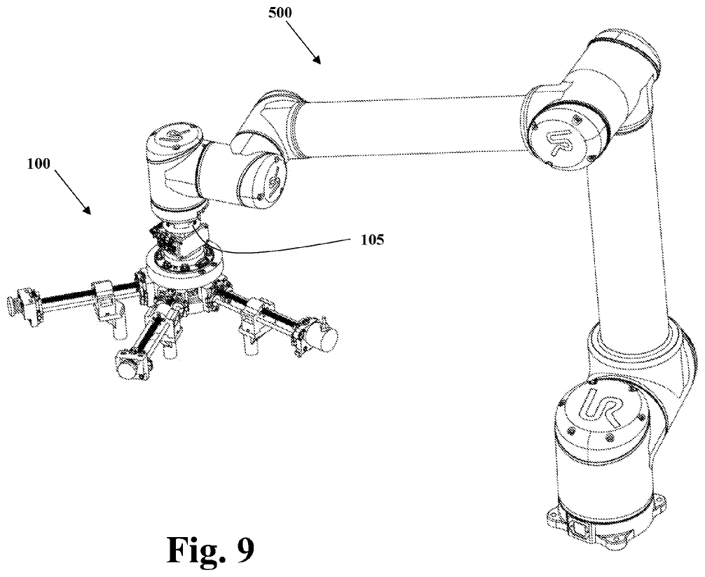

FIG. 9 shows an embodiment of the present invention system with the system arm 500 connected to upper connection plate 105 of hand 100. An example of the system arm is a Universal Robotics UR10 robotic arm. Other robotic arms such as Motoman robotic arms could also be used.

The motor 201 may be for example a Dynamixel PM 54 servo motor. The motors 202, 203 may be for example a DC brushed motor with a gear reduction. The motor 101 driving the face gear 110uf in hand 100 may be for example a NEMA 17 stepper motor.

The lead screw 135, 235 length is preferably between 220 and 400 mm. Its diameter is preferably between 8 and 12 mm.

The rods' 171, 271 lengths are preferably between 210 and 380 mm. Their diameters are preferably between 6 and 12 mm.

The distal plunger surface 161 and distal driving element 261 have a diameter preferably between 10 and 60 mm. Their thickness is preferably between 3 and 10 mm. The coil spring 162 has a diameter preferably between 10 and 50 mm.

The distal vertical surface 160, 260 has a length preferably between 10 and 40 mm. Its width is preferably between 20 and 50 mm. Its thickness is preferably between 10 and 30 mm.

The proximal vertical surface 150, 250 has a length preferably between 15 and 40 mm. Its width is preferably between 20 and 50 mm. Its thickness is preferably between 10 and 50 mm.

The upper follower vertical surface member 170f, 270f has a length preferably between 20 and 50 mm. Its width is preferably between 20 and 50 mm. Its thickness is preferably between 10 and 40 mm.

The lower object engaging/grasping member 170g, 270g has a length preferably between 10 and 100 mm. Its diameter is preferably between 3 and 30 mm.

The intermediate surface 170i, 270i has a thickness preferably between 3 and 10 mm.

The upper housing plate 110u, 210u and lower housing plate 110L, 210L have a diameter preferably between 60 and 240 mm. Their thickness is preferably between 20 and 70 mm.

The circular face gears 110uf, 110Lf, 210uf, 210Lf, have a diameter preferably between 70 and 200 mm. The lengths of their meshing teeth are preferably between 10 and 30 mm.

The diameter of the spur gear 136, 236 is preferably between 10 and 40 mm. Its thickness is preferably between 30 and 60 mm.

The length of distal portion 136d, 236d is preferably between 0 and 40 mm. Its diameter is preferably between 6 and 36 mm.

The width of peripheral channel 110uc, 210uc is preferably between 3 and 10 mm. Its depth is preferably between 3 and 10 mm.

Top protrusion 150t, 250t and bottom protrusion 150b, 250b have a length preferably between 3 and 10 mm. Their thickness is preferably between 3 and 10 mm.

The upper connection plate 105 has a diameter preferably between 40 and 100 mm. Its thickness is preferably between 8 and 20 mm.

The engaging member 265 has a length preferably between 20 and 50 mm. Its diameter is preferably between 30 and 60 mm.

Surface 211 has a length preferably between 400 and 1500 mm. Its width is preferably between 400 and 1000 mm. Its thickness is preferably between 3 and 20 mm.

Lower descended surface 205 has a length preferably between 60 and 300 mm. Its width is preferably between 60 and 300 mm. Its height (distance from surface 211) is preferably between 50 and 250 mm. The lengths of surfaces 215, 208 and 209 may be along the width of surface 205. Their height is preferably within the range of between 40 and 100 mm.

The present invention system may comprise a power unit (not shown) electrically coupled to all of the motors, cameras, controller, etc., in the system, and configured to power them. Optionally, the power unit is electrically coupled to an external power source (e.g. external power socket). The controller is connected to all of the motors, cameras, and the other electric units in the system and is configured to activate them.

Other embodiments of the present invention may include other mechanisms (other than the lead screw and follower mechanism) for displacing the fingertips distally and proximally, for example, a cable driven mechanism, a telescopic mechanism, a pneumatic or electric cylinder approach, etc.

The present invention relates to a system for manipulating an object comprising:
a grasping hand as explained herein (100, 200);
a robotic arm (e.g. 500) connected to said grasping hand;
a camera; and
a control unit comprising a processor.

The present invention method is explained hereinbelow, however, part of the present invention method has been explained hereinabove in conjunction with the description of the device/system explained hereinabove.

The present invention relates to a method for grasping and manipulating an object comprising:
providing the system as explained herein;
adjusting the hand for grasping comprising:
   angularly displacing one or more of the fingers; and/or
   linearly displacing one or more of the fingertips;
displacing the hand such that the object is placed within the volume surrounded by the fingertips;
retracting the fingertips proximally to grasp the object;
manipulating the object; and
releasing the object by displacing the fingertips distally.

Preferably, adjusting the hand further comprises the following pre stages (before the angularly displacing and before the linearly displacing):
imaging the object to be grasped;
obtaining a shape resembling the peripheral circumference of the object;
calculating angular positions of the fingers and linear positions of the of the fingertips for grasping according to said obtained shape (e.g. the calculating is carried out using a program such as MATLAB, first finding the grasping points in relation and according to the shape, then translating that to the finger and fingertips' required location).

Preferably, providing the hand 100;
wherein angularly displacing each finger comprises:
maneuvering the hand such that the finger to be angularly displaced driving member is pushed proximally thereby disconnecting the spur gear from meshing with the face gears; rotating the palm;
maneuvering the hand such that the driving member returns distally thereby positioning the spur gear to mesh with the face gears.

Preferably, providing the hand 100;
wherein linearly displacing each fingertip comprises: maneuvering the hand such that the fingertip to be displaced finger driving member is pushed proximally (e.g. by pushing the hand towards an environment item such as a wall) thereby disconnecting the spur gear from meshing with the face gears; linearly displacing the fingertips of the other hand fingers; maneuvering the hand such that the driving member returns distally thereby positioning the spur gear to mesh with the face gears.

Preferably, providing the hand 200;
wherein angularly displacing each finger comprises: rotating the palm (by motor 201) such that the finger to be angularly displaced driving member is positioned aligned with the engaging member (e.g. FIG. 5A);
displacing the engaging member proximally (by motor 203) thereby pushing the driving member proximally and disconnecting the spur gear from meshing with the face gears; rotating the palm;
displacing the engaging member distally (by motor 203) such that the driving member returns distally (by the plunger spring affect) thereby positioning the spur gear to mesh with the face gears.

Preferably, providing hand 200;
wherein linearly displacing the fingertips comprises: rotating the palm (by motor 201) such that a finger driving member is positioned aligned with the engaging member; displacing the engaging member proximally (by motor 203) until it engages the finger distal driving member (261) displacing the fingertips (by rotating the distal driving member 261);
displacing the engaging member distally (by motor 203).

Preferably, providing hand 200;
wherein linearly displacing a single fingertip comprises: rotating the palm (by motor 201) such that the finger of the fingertip to be linearly displaced driving member is positioned aligned with the engaging member;
displacing the engaging member proximally (by motor 203) thereby pushing the driving member proximally and disconnecting the spur gear from meshing with the face gears; displacing the fingertip (by rotating the distal driving member 261);
displacing the engaging member distally (by motor 203) such that the driving member returns distally (by the plunger spring affect) thereby positioning the spur gear to mesh with the face gears.

The method may be carried out by hand 300 as explained in relation to hand 200, wherein displacing the engaging member proximally/distally is carried out by the corresponding arm 350 (revolute joints or other mechanisms-telescopic mechanism pneumatic or electric cylinder approach, etc.). Displacing the fingertip(s) (by rotating the distal driving member 261) may be carries out by rotating a corresponding segment or by means of an internal motor, etc., mutatis mutandis.

The present invention method portion of calculating angular positions of the fingers and linear positions of the fingertips for grasping may comprise the following possibility as explained in the following section. This section describes a novel approach for selecting a grasp configuration for an object. When using a non-configurable robot hand, any grasp configuration must conform to the hand shape. For instance, if an equidistant, three-fingered hand is used, only grasp configurations that constitute equilateral triangles may be considered. The present invention approach utilizes the reconfiguration ability of the hand to maximize grasp quality by relaxing the finger positioning constraints. A grasp configuration is defined as the fingertip placements on the object's perimeter. A hand structure is defined as a combination of the grasp configuration and the location of the hand's center. Although the hand allows total freedom in grasp configuration selection, physical constraints still exist, so not every hand structure is possible.

The decision process for finger placement—the grasp configuration is thereby examined. The object is given as a polygon in configuration space. i.e., the object has been represented as a polygon, and dilated by the radius of the fingertips. This means that any point on the boundary of the configuration-space object corresponds to a fingertip-object contact point. The friction coefficient between the fingertips and the object p is known, as is the number of fingers k. The grasp configuration is now chosen. To do this, a Monte-Carlo simulation of grasp configurations is used. The polygon perimeter is discretized as a set of points, each with its own location and normal direction. Then, k fingertips are randomly placed at different points on the polygon perimeter, and test the grasp quality. There are many grasp quality measures. This procedure grants the user the option to choose between wrench space sphere radius and grasp matrix ellipsoid quality measures, although any other quality measure can be used.

The grasp is evaluated, and its quality is marked according to the guidelines of the quality measure. If the grasp is found to be immobilizing, the grasp configuration enters a list of possible grasp configurations. After exhausting the user-defined number of grasp attempts, the list is sorted by grasp quality. A list of immobilizing grasp configurations, sorted by their quality is then obtained. While all of these grasps are immobilizing, the physical structure of the hand imposes another constraint; not all of these immobilizing grasp configurations are actually feasible. A candidate hand structure is feasible if a hand center exists for the given grasp configuration. Therefore, each grasp configuration can be examined to determine its potential as a feasible hand structure. Starting from the best grasp configuration in the list, it is tested to see if a hand structure can be synthesized, i.e., it is tested to see if a hand center point P exists with its fingers at the candidate grasp configuration. This test is performed by converting the physical hand limitations to three geometric constraints.

Consider the point P representing the center of the hand. The first physical limitation of P is angular. Two neighboring digits cannot be at angles less than δ apart.

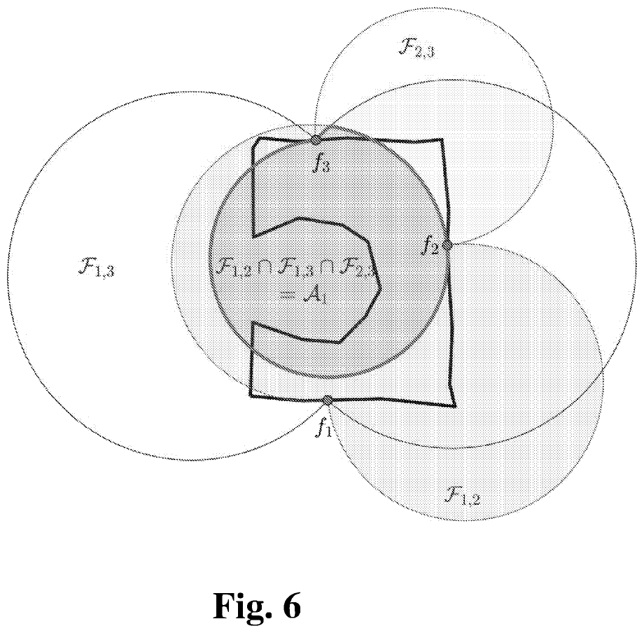

This limitation can be described geometrically as two overlapping discs, shown in FIG. 6. Consider two fingertip placements, fᵢ and fⱼ. The hand center P must be located such that the digit vectors are no more than δ degrees apart, or:

∠(\vec{fᵢ−P},\vec{fⱼ−P})=δ.

The set of points P that conform to this rule lie within the union of two overlapping discs. Each disc is bounded by fᵢ and fⱼ. Each point on the perimeter of either disc is such that

If the distance between fi and fj is di,j, then the radii of the two discs are:

$${r}_{i , j} = \frac{{d}_{i , j}}{2 sin ( δ )} .$$

The center of the hand, therefore, must lie within the area:

[symbol]

_{i,j}= [symbol] _{i,j}¹∪ [symbol] _{i,j}²
where [symbol] _{i,j}¹ and [symbol] _{i,j}² are the two discs with radius r_{i,j} that have fᵢ and fⱼ lying on their perimeters. The hand center must lie in this area for every pair of fingers fᵢ, fⱼ. Therefore, the hand s center must lie within the area [symbol] ₁:

[symbol]

₁=∩ [symbol] _{i,j} for 1≤i,j≤k,i≠j.

This constraint can be seen in FIG. 6 for a three-finger hand.

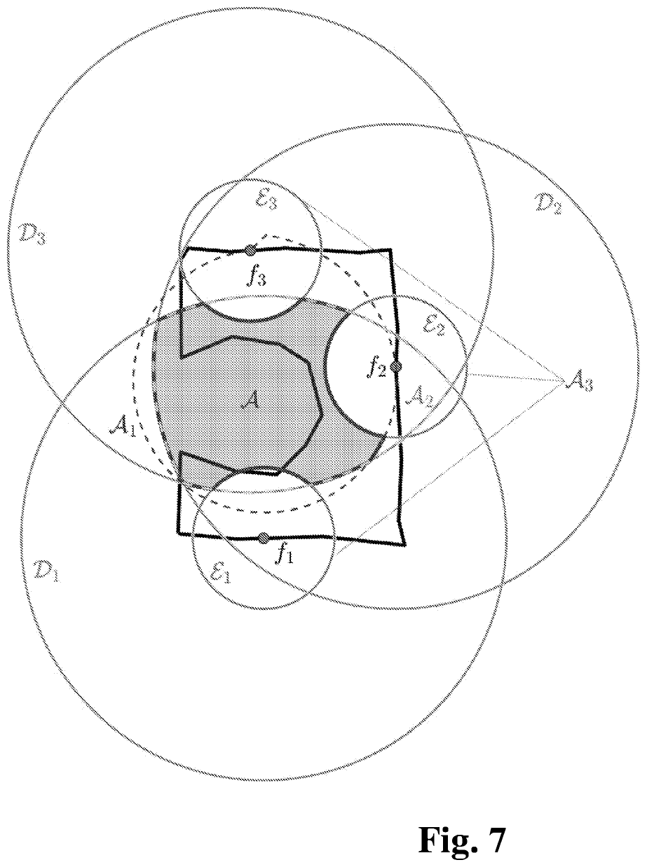

The second constraint is that the hand center P must lie within a circle of radius Lₘₐₓ centered at each fingertip placement, where Lₘₐₓ is the maximal extension of a fingertip. Therefore, the hand center must lie within the area A₂:

$${𝒜}_{2} = {{⋂}^{k}}_{i = 1} {𝒟}_{i} \qquad ( 5 )$$

where [symbol] ᵢ a circle of radius Lₘₐₓ centered at the i^{th} finger-tip placement. This can be seen in FIG. 7, as magenta circles surrounding the fingertip placements.
   Similarly, the hand center cannot lie too close to a fingertip placement, since there is a minimum extension Lₘᵢₙ. Therefore, the hand center cannot lie within the area [symbol] ₃:

$${𝒜}_{3} = {{⋃}^{k}}_{i = 1} {ε}_{i} \qquad ( 6 )$$

where εᵢ is a circle of radius Lₘᵢₙ centered at the i^{th} fingertip placement. This can be seen in FIG. 7, as red circles surrounding the fingertip placements.

Finally, the geometric constraints are combined to obtain the valid area for the hand center. Any point P in this area is a physically feasible placement for the hand center:

[symbol]

= [symbol] ₁∩ [symbol] ₂∩ [symbol] .
where [symbol] = [symbol] ²− [symbol] ₃. This area is illustrated in FIG. 7.

Any point in A that allows a squeezing grasp of the object is valid, and as far as grasp quality they are identical. However, some hand center positions are better in other regards. Special centers that have certain advantages can be identified. For instance, a special center for three-fingered hands is the center of the circle defined by the three fingertip placements. This center has two advantages: 1) Each of the three fingertips is equidistant from the center. If the previous grasp configuration was also equidistant, the hand's distances adjustment procedure is exceedingly short. 2) If a triangle is defined by the three fingertip placements, it is noted that extending or retracting the fingertips maintains a similar triangle. Similar triangle formations can be used to compute caging regions on polygons, potentially increasing grasp reliability and robustness using caging grasps.

If the preferred hand center is not feasible, one prefers hand centers that require shorter adjustment procedures of the hand. Each hand center Pi corresponds with a hand structure

Cᵢ=(\vec{θ}ᵢ,\vec{d}ᵢ).

Starting from the hand's current structure, C₀, each of the alternative structures, Cᵢ, may take a different number of adjustments to achieve. Therefore, adjustment procedures for every structure is constructed. After synthesizing the adjustment procedure for each candidate hand structure, the hand center that requires the shortest adjustment procedure is chosen. At this point, a number of valid hand structures have been found.

FIG. 6 shows an example of the angular geometric constraints of finger placement. The object (black outline) is grasped by three fingertips (red dots). The angle between two digits must be at least δ=45 degrees. For each pair of fingers, the union of two discs bounds the hand's center area. In this instance, fingers 1 and 2 only allow the placement of the hand center within the double-circle magenta shape F_{1,2}. The intersection of all the pairs results in the allowed area (red border).

FIG. 7. is a continuation of the example from FIG. 6. The object is grasped by three fingertips (red dots). The hand center must lie within a distance of Lₘₐₓ from each fingertip (magenta circles). The intersection of these circles is A₂ (dashed green curves). The hand center cannot lie within Lₘᵢₙ from any fingertip (red circles). The union of these circles is A₃. To conform with angle restrictions, the hand center must lie inside the area A₁ (brown dashed curves). The blue area, marked A, is the result of these restrictions, where the hand center can be placed.

While some of the embodiments of the invention have been described by way of illustration, it will be apparent that the invention can be carried into practice with many modifications, variations and adaptations, and with the use of numerous equivalents or alternative solutions that are within the scope of a person skilled in the art, without departing from the spirit of the invention, or the scope of the claims.

1. A robotic grasping hand comprising:
a central palm;
a plurality of fingers connected to said palm, each of said fingers comprises a fingertip movable along a length of said fingers;
wherein the fingers are placed on a common imaginary plane and are angularly displaceable thereon.

2. The robotic grasping hand according to claim 1, wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element;
wherein each lead screw comprises a spur gear fixedly attached to its proximal side;
wherein each of said spur gears is configured to mesh with said first and second face gears; and
wherein said lead screw and said follower element form a lead screw and follower mechanism.

3. The robotic grasping hand according to claim 2, wherein each fingertip comprises a grasping member extending vertically downwards.

4. The robotic grasping hand according to claim 2, wherein each finger comprises a proximal vertical surface near its proximal end and a distal vertical surface near its distal end; wherein each finger comprises one or more rods that pass through the follower surface member and that are fixed between said proximal vertical surface and said distal vertical surface.

5. The robotic grasping hand according to claim 4, wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears.

6. The robotic grasping hand according to claim 4,
wherein the upper housing plate bottom portion comprises a peripheral channel placed around the first face gear;
wherein the lower housing plate top portion comprises a second peripheral channel placed around the second face gear; and
wherein the proximal vertical surface comprises a top protrusion placed inside said first peripheral channel and a bottom protrusion placed inside said second peripheral channel.

7. The robotic grasping hand according to claim 1, further comprising a thumb finger connected to the palm;
said thumb finger comprises a fingertip movable along its length;
wherein the thumb finger is placed on the common imaginary plane; and
wherein said thumb finger is not angularly displaceable in relation to said palm.

8. The robotic grasping hand according to claim 5, wherein the hand further comprises a central shaft anchored to the upper housing plate and lower housing plate;
wherein said shaft comprises a keyseat;
wherein the first or second face gear comprises a keyway; and
wherein said hand comprises a key placed within said keayseat and keyway.

9. The robotic grasping hand according to claim 5, wherein the distal driving member is a distal plunger surface.

10. The robotic grasping hand according to claim 5, wherein said hand further comprises a motor configured to drive and rotate the first or second face gear.

11. The robotic grasping hand according to claim 10, wherein the motor is configured to drive and rotate the shaft.

12. The robotic grasping hand according to claim 5, wherein the palm is connected to a flat surface and rotatable thereon;
wherein said hand comprises an engaging member configured to engage and displace the distal driving element proximally and configured to rotate it.

13. The robotic grasping hand according to claim 12, wherein said hand comprises:
a first motor configured to rotate the palm;
a second motor configured to linearly move the engaging member distally and proximally; and
a third motor configured to rotate the engaging member.

14. The robotic grasping hand according to claim 13, wherein said hand further comprises a bearing member comprising a second follower element;
wherein said hand further comprises a second lead screw extending proximally from said second motor and passing through said second follower element;
wherein the second motor is configured to drive and rotate the second lead screw;
wherein said second lead screw and said second follower element form a lead screw and follower mechanism; and
wherein the third motor is mounted on said bearing member.

15. The robotic grasping hand according to claim 14, wherein said hand comprises a distal vertical bearing surface and a proximal vertical bearing surface;
wherein said hand comprises one or more secondary rods that pass through the bearing member and that are fixed between said proximal vertical surface and said distal vertical surface.

16. The robotic grasping hand according to claim 14, comprising an axel extending proximally from the third motor and connected to the engaging member such that said third motor is configured to rotate said axel and thereby said engaging member.

17. The robotic grasping hand according to claim 16, wherein the distal driving element comprises a protrusion compatible with the engaging member.

18. The robotic grasping hand according to claim 17, wherein the engaging member is a universal socket.

19. The robotic grasping hand according to claim 12, wherein said hand comprises:
a first motor configured to rotate the palm;
a robotic arm connected to the flat surface, configured to linearly move the engaging member distally and proximally and configured to rotate the engaging member.

20. A system for manipulating an object comprising:
a grasping hand according to claim 1;
a robotic arm connected to said grasping hand;
a camera; and
a control unit comprising a processor.

21. A method for grasping and manipulating an object comprising:
providing the system of claim 20;
adjusting the hand for grasping comprising:
angularly displacing one or more of the fingers; and/or
linearly displacing one or more of the fingertips;
displacing the hand such that the object is placed within the volume surrounded by the fingertips;
retracting the fingertips proximally to grasp the object;
manipulating the object; and
releasing the object by displacing the fingertips distally.

22. The method according to claim 21 wherein adjusting the hand further comprises the following pre stages:
imaging the object to be grasped;
obtaining a shape resembling the peripheral circumference of the object; and
calculating angular positions of the fingers and linear positions of the of the fingertips for grasping according to said obtained shape.

23. The method according to claim 21,
providing the hand,
wherein the hand comprises:
a central palm;
a plurality of fingers connected to said palm, each of said fingers comprises a fingertip movable along a length of said fingers;
wherein the fingers are placed on a common imaginary plane and are angularly displaceable thereon;
wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element wherein each lead screw comprises a spur gear fixedly attached to its proximal side;
wherein each of said spur gears is configured to mesh with said first and second face gears; and
wherein said lead screw and said follower element form a lead screw and follower mechanism;
wherein each finger comprises a proximal vertical surface near its proximal end and a distal vertical surface near its distal end;
wherein each finger comprises one or more rods that pass through the follower surface member and that are fixed between said proximal vertical surface and said distal vertical surface;
wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears;
wherein said hand further comprises a motor configured to drive and rotate the first or second face gear;
wherein the motor is configured to drive and rotate the shaft;
wherein angularly displacing each finger comprises:
maneuvering the hand such that the finger to be angularly displaced driving member is pushed proximally thereby disconnecting the spur gear from meshing with the face gears;
rotating the palm; and
maneuvering the hand such that the driving member returns distally thereby positioning the spur gear to mesh with the face gears.

24. The method according to claim 21,
providing the hand;
wherein the hand comprises:
a central palm;
a plurality of fingers connected to said palm, each of said fingers comprises a fingertip movable along a length of said fingers;
wherein the fingers are placed on a common imaginary plane and are angularly displaceable thereon;
wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element wherein each lead screw comprises a spur gear fixedly attached to its proximal side;
wherein each of said spur gears is configured to mesh with said first and second face gears; and
wherein said lead screw and said follower element form a lead screw and follower mechanism;
wherein each finger comprises a proximal vertical surface near its proximal end and a distal vertical surface near its distal end;
wherein each finger comprises one or more rods that pass through the follower surface member and that are fixed between said proximal vertical surface and said distal vertical surface;
wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears;
wherein said hand further comprises a motor configured to drive and rotate the first or second face gear;
wherein the motor is configured to drive and rotate the shaft;
wherein linearly displacing each fingertip comprises:
maneuvering the hand such that the fingertip to be displaced finger driving member is pushed proximally thereby disconnecting the spur gear from meshing with the face gears;
linearly displacing the fingertips of the other hand fingers; and
maneuvering the hand such that the driving member returns distally thereby positioning the spur gear to mesh with the face gears.

25. The method according to claim 21,
providing the hand, the hand comprising:
a central palm;
a plurality of fingers connected to said palm, each of said fingers comprises a fingertip movable along a length of said fingers;
wherein the fingers are placed on a common imaginary plane and are angularly displaceable thereon;
wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element; wherein each lead screw comprises a spur gear fixedly attached to its proximal side;
wherein each of said spur gears is configured to mesh with said first and second face gears; and
wherein said lead screw and said follower element form a lead screw and follower mechanism;
wherein each finger comprises a proximal vertical surface near its proximal end and a distal vertical surface near its distal end;
wherein each finger comprises one or more rods that pass through the follower surface member and that are fixed between said proximal vertical surface and said distal vertical surface;
wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears;
wherein the palm is connected to a flat surface and rotatable thereon;
wherein said hand comprises an engaging member configured to engage and displace the distal driving element proximally and configured to rotate it;
wherein angularly displacing each finger comprises:
rotating the palm such that the finger to be angularly displaced driving member is positioned aligned with the engaging member;
displacing the engaging member proximally thereby pushing the driving member proximally and disconnecting the spur gear from meshing with the face gears;
rotating the palm; and
displacing the engaging member distally such that the driving member returns distally thereby positioning the spur gear to mesh with the face gears.

26. The method according to claim 21,
providing the hand, the hand comprising:
a central palm;
a plurality of fingers connected to said palm, each of said fingers comprises a fingertip movable along a length of said fingers;
wherein the fingers are placed on a common imaginary plane and are angularly displaceable thereon;
wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element wherein each lead screw comprises a spur gear fixedly attached to its proximal side;
wherein each of said spur gears is configured to mesh with said first and second face gears; and
wherein said lead screw and said follower element form a lead screw and follower mechanism;
wherein each finger comprises a proximal vertical surface near its proximal end and a distal vertical surface near its distal end;
wherein each finger comprises one or more rods that pass through the follower surface member and that are fixed between said proximal vertical surface and said distal vertical surface;
wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears;
wherein the palm is connected to a flat surface and rotatable thereon;
wherein said hand comprises an engaging member configured to engage and displace the distal driving element proximally and configured to rotate it;
wherein linearly displacing the fingertips comprises:
rotating the palm such that a finger driving member is positioned aligned with the engaging member;
displacing the engaging member proximally until it engages the finger distal driving member;
displacing the fingertips; and
displacing the engaging member distally.

27. The method according to claim 21,
providing the hand; the hand comprising:
a central palm;
a plurality of fingers connected to said palm, each of said fingers comprises a fingertip movable along a length of said fingers;
wherein the fingers are placed on a common imaginary plane and are angularly displaceable thereon:
wherein the palm comprises:
an upper housing plate comprising a first face gear rotatable therewithin;
a lower housing plate comprising a second face gear rotatable therewithin;
wherein each fingertip comprises a follower surface member comprising a follower element;
wherein each finger comprises a lead screw along its length passing through said follower element wherein each lead screw comprises a spur gear fixedly attached to its proximal side;
wherein each of said spur gears is configured to mesh with said first and second face gears; and
wherein said lead screw and said follower element form a lead screw and follower mechanism;
wherein each finger comprises a proximal vertical surface near its proximal end and a distal vertical surface near its distal end;
wherein each finger comprises one or more rods that pass through the follower surface member and that are fixed between said proximal vertical surface and said distal vertical surface;
wherein the lead screw passes through the proximal vertical surface and the distal vertical surface;
wherein each finger comprises a distal driving member fixedly attached to the lead screw distal side, and a spring placed between said distal driving member and said distal vertical surface; and
wherein the lead screw is proximally displaceable such that the spur gear is configured to move proximally to a position where said spur gear does not mesh with the face gears;
wherein the palm is connected to a flat surface and rotatable thereon;
wherein said hand comprises an engaging member configured to engage and displace the distal driving element proximally and configured to rotate it;
wherein linearly displacing a single fingertip comprises:
rotating the palm such that the finger of the fingertip to be linearly displaced driving member is positioned aligned with the engaging member;
displacing the engaging member proximally thereby pushing the driving member proximally and disconnecting the spur gear from meshing with the face gears;
displacing the fingertip; and
displacing the engaging member distally such that the driving member returns distally thereby positioning the spur gear to mesh with the face gears.
